(19) United States
(12) Patent Application Publication
(10) Pub. No.: US 2005/0251463 A1
(43) Pub. Date: Nov. 10, 2005

(54) Hairstyle suggesting system, hairstyle suggesting method, and computer program product

(75) Inventors: Yuki Nagai, Tokyo (JP); Kuniko Ushiro, Tokyo (JP); Yoshiro Matsunami, Tokyo (JP); Tsuyoshi Hashimoto, Tokyo (JP); Yuusuke Kojima, Tokyo (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Tokyo (JP)

(21) Appl. No.: 11/122,217

(22) Filed: May 5, 2005

(30) Foreign Application Priority Data
May 7, 2004 (JP) 2004-139016

(51) Int. Cl. G06F 17/60; A45D 20/08

(52) U.S. Cl. 705/27

(57) ABSTRACT

Attribute data for indicating the attributes of a customer and feature parameters for indicating physical features are recorded in a customer chart. In a server, from among a plurality of hairstyle data and coloring data stored in a style content database in advance in association with the attribute data and the feature parameters, hairstyle data and coloring data which match the attribute data and the feature parameters of the customer recorded in the customer chart are searched for. At the same time, the image of the face portion of customer imaged in advance are combined with the searched hairstyle data and coloring data, to thereby generate the image of the customer. The generated image is suggested to the customer, as the image of the customer having a hairstyle that objectively suits the customer.

### BACKGROUND OF THE INVENTION

1. Field of the Invention

The present invention relates to a hairstyle suggesting system, a hairstyle suggesting method, and a computer program product.

2. Description of the Related Art

If having their hair cut at a beauty shop, most of the time, customers select desired hairstyles from magazines and hair catalogs prepared in advance. In this method, quite a few customers make complaints about the hairstyles after the hair cut. This results from that the understanding of stylists does not match that of the customers. Thus, there are suggested techniques for reducing such complaints (refer to Japanese Patent Application Laying Open NO. 2001-344492, Japanese Patent Application Laying Open NO. 2002-328995, and Japanese Patent Application Laying Open NO. 2000-231623, for example).

According to a beauty shop selecting system described in Japanese Patent Application Laying Open NO. 2001-344492 (hereinafter referred to as a first conventional technique), if a search condition, such as a hairstyle, is inputted from an information terminal owned by a customer, a searching device searches for a beauty shop which satisfies the search condition, from a first database in which shop information, stylist information, and the like are stored. Therefore, it describes that the customer can select the beauty shop at which the desired hairstyle is satisfied.

Moreover, according to a hairstyle simulation system described in Japanese Patent Application Laying Open NO. 2002-328995 (hereinafter referred to as a second conventional technique), it has a hairstyle database in which a plurality of hairstyle samples are stored, and a user database in which picture data about users' head portions are stored. It describes that only by inputting the image of a hairstyle desired by a user, the user can look at a hairstyle that matches the image. It also describes that by combining the hairstyle with the picture data of the user, the user can confirm whether or not the hairstyle suits the self. Incidentally, a technique in which the confirmation is possible is also disclosed in Japanese Patent Application Laying Open NO. 2000-231623 (hereinafter referred to as a third conventional technique).

Such techniques, however, have the following problems.

In the first conventional technique, it is only possible to select the beauty shop depending on hairstyles. It is impossible to confirm whether or not the searched hairstyle suits the customer himself or herself. Moreover, in the second and third techniques, it is only possible that the customer subjectively confirms consistency with his or her desired hairstyle, and it is difficult for the customer to confirm whether or not the hairstyle really suits the self. Namely, in such conventional techniques, it is difficult for the customer to find out the hairstyle that suits the self on the basis of objective data.

### SUMMARY OF THE INVENTION

It is therefore an object of the present invention to provide a hairstyle suggesting system, a hairstyle suggesting method, and a computer program product, which can suggest a hairstyle that suits a customer with respect to the customer, for example.

<Hairstyle Suggesting System>

The above object of the present invention can be achieved by a hairstyle suggesting system provided with: a first database for storing therein a plurality of hairstyle image data in association with feature parameters for indicating predetermined features of an arbitrary customer; a specifying device for specifying at least one of the feature parameters corresponding to at least one of the features of one customer; a searching device for searching for hairstyle image data which matches the specified at least one of the feature parameters, from the hairstyle image data stored in the first database; an image generating device for generating a first image to be suggested to the one customer on the basis of the searched hairstyle image data; and a displaying device for displaying the first image.

According to the hairstyle suggesting system of the present invention, in its operation, at least one of the feature parameters for indicating the features of the customer is specified by the specifying device. The searching device searches for the hairstyle image data which matches the specified at least one of the feature parameters, from the first database for storing therein in advance the plurality of hairstyle image data in association with the feature parameters. The first image to be suggested to the customer, whose at least one of the feature parameters is specified, is generated from the searched image data and is displayed by the displaying device.

Here, the “feature parameters” indicate physical features, such as a face shape, a hair condition, a hair volume, curliness, and complexion.

The hairstyle image data stored in the first database is stored in association with the feature parameters, so that the searching device can search for a hairstyle which is objectively judged to suit the customer. Namely, the hairstyle searched for by the searching device may be totally different from the hairstyle subjectively selected by the customer on the basis of the self preference as conventionally performed. Thus, suitability is ensured objectively to some extent. The first image generated on the basis of the image data which is searched for in this manner is the image of the hairstyle “that suits the customer” objectively, regardless of the customer preference, or further narrowed in the range of the customer preference. Therefore, according to the hairstyle suggesting system of the present invention, it is possible to suggest the hairstyle that suits the customer.

In one aspect of the hairstyle suggesting system, the first database further stores therein a plurality of hair color image data in association with the feature parameters, the searching device further searches for hair color image data which matches the specified at least one of the feature parameters, from the hair color image data stored in the first database, the image generating device further generates a second image to be suggested to the one customer on the basis of the searched hair color image data, and the displaying device further displays the second image.

According to this aspect, the first database further stores therein the hair color image data in association with the feature parameters, so that the searching device can search for the hair color image data which suits the customer. Therefore, as with the hairstyle, it is possible to suggest the hair color that suits the customer.

In another aspect of the hairstyle suggesting system, the image generating device generates the second image on the basis of the searched hair color image data and the generated first image.

According to this aspect, the second image is generated on the basis of the searched hair color image data and the first image, so that it is possible to suggest the hairstyle and the hair color that suit the customer at the same time.

In another aspect of the hairstyle suggesting system, the specifying device is provided with: an image pickup device for imaging the one customer; and a customer image data generating device for generating image data of the imaged customer, and specifies at least one of the feature parameters on the basis of the generated image data of the customer.

According to this aspect, the image data of the customer is generated by the image pickup device and the customer image data generating device, and at least one of the feature parameters is specified on the basis of the image data of the customer. Thus, the feature parameters have extremely high objectivity, which allows high-quality suggestion to the customer.

In another aspect of the hairstyle suggesting system, the image generating device generates the first image or the second image on the basis of the generated image data of the customer and at least one of the searched hairstyle image data and the searched hair color image data.

According to this aspect, the first or second image is generated on the basis of the image data of the customer, which allows high-quality suggestion to the customer.

In another aspect of the hairstyle suggesting system, the first database stores therein a plurality types of image data of samples each including a head portion in association with the feature parameters, the searching device further searches for image data of a sample, which matches the specified at least one of the feature parameters, from the plurality of image data of samples stored in the first database, and the image generating device generates the first image or the second image on the basis of (i) at least one of the searched hairstyle image data and the searched hair color image data and (ii) at least one of the generated image data of the customer and the searched image data of the sample.

According to this aspect, the first database further stores therein the plurality types of image data of samples each including the head portion, and the first or second image is generated on the basis of at least one of the image data of the customer and the image data of the sample. This expands the range of the selections of the first or the second image, and allows higher-quality suggestion to the customer.

In another aspect of the hairstyle suggesting system, there are a plurality types of feature parameters, and order of priority is given in advance to respective one of the feature parameters, and the searching device searches for the hairstyle image data or the hair color image data which matches the specified at least one of the feature parameters, in accordance with the order of priority.

According to this aspect, if there are the plurality types of feature parameters, it is possible to improve the searching efficiency of the searching device because the order of priority is given to respective one of the feature parameters.

In another aspect of the hairstyle suggesting system, the hairstyle suggesting system is further provided with an outputting device which can output the first image or the second image which is displayed on the displaying device, to a predetermined recording medium.

According to this aspect, the display result by the displaying device can be outputted to the predetermined recording medium, so that it is possible to suggest the hairstyle or the hair color, regardless of a place, time, and the like.

Incidentally, “output the first or second image to the predetermined recording medium” described herein includes recording as the image data onto an optical information recording medium, such as a CD-R (Compact Disc-Recordable), a CD-RW (CD-ReWritable), a DVD-R (Digital Versatile Disc-Recordable), and a DVD-RAM (DVD-Random Access Memory), or onto an magneto optical recording medium, such as a MO, and printing the data to a medium, such as paper and a film. It conceptually includes all the aspects in which the hairstyle can be suggested to the customer.

As described above, if the first or second image can be outputted to the recording medium, it is possible to easily confirm the images and pictures even in a place where the hairstyle suggesting system of the present invention is not installed, for example, even at the customer's home. Moreover, it is also possible for a stylist or the like to easily confirm the suggested hairstyle in a place where the hairstyle suggesting system of the present invention is installed, such as beauty shops and hair salons.

In another aspect of the hairstyle suggesting system, at least one of the plurality of hairstyle image data and the plurality of hair color image data, which are stored in the first database, can be added, deleted, or changed.

According to this aspect, at least one of the hairstyle image data and the hair color image data, which are stored in the first database, can be added, deleted, or changed. Thus, it is possible to perform higher-quality suggestion to the customer.

In another aspect of the hairstyle suggesting system, the first database newly stores therein at least one of the generated first image and the generated second image, as at least one of the hairstyle image data and the hair color image data.

According to this aspect, at least one of the first image and the second image can be stored as at least one of the hairstyle image data and the hair color image data. Thus, at least one of the hairstyle image data and the hair color image data is gradually enriched over time, which increases the quality of the suggestion to the customer.

In another aspect of the hairstyle suggesting system, the hairstyle suggesting system is further provided with: an inputting device capable of inputting therethrough predetermined attributes for indicating basic attributes of the one customer, as attribute data, for each customer; and a second database for storing therein the inputted attribute data for each customer, wherein the second database further stores therein the specified at least one of the feature parameters in association with the inputted attribute data, the first database further stores therein at least one of the hairstyle image data and the hair color image data, in association with the attributes, the searching device further searches the first database for at least one of the hairstyle image data and the hair color image data, which match the inputted attribute data, and the image generating device further generates the first image or the second image on the basis of at least one of the searched hairstyle image data and the searched hair color image data.

Furthermore, the first database may further store therein at least one of the hairstyle image data, the hair color image data, and the image data of the sample including the head portion, in association with the attributes, the searching device further searches the first database for at least one of the hairstyle image data, the hair color image data, and the image data of the sample, which match the inputted attribute data, and the image generating device further generates the first image or the second image on the basis of at least one of the searched hairstyle image data, the searched hair color image data, and the searched image data of the sample.

Here, the “attributes” are information for indicating a name, age, sex, job, hobby, purposes, date of visit, and the like. The attributes are inputted as the attribute data for each customer. The attribute data inputted for each customer is stored in the second database. In this case, the specified at least one of the feature parameters is stored in association with the attribute data, in the second database. Moreover, at least one of the hairstyle image data, the hair color image data, and the sample image data which are stored in the first database, is stored in association with the attributes. Therefore, according to this aspect, it is possible to facilitate the management of the customer, and it is also possible to perform higher-quality suggestion on the basis of the attributes of the customer.

In another aspect of the hairstyle suggesting system, the first database, the specifying device, the searching device, the image generating device, and the second database are included in a network and provided for a server communicable via the network, the inputting device and the displaying device are included in the network and provided for a client which can communicate with the server via the network, the client transmits the inputted attribute data to the server via the network, the server stores the transmitted attribute data into the second database, and transmits at least one of the first and second images generated by the image generating device, to the client via the network, and the client displays the received first or second image.

According to this aspect, the first database, the specifying device, the searching device, the image generating device, and the second database are included in the network and provided for the server communicable via the network. Moreover, the inputting device and the displaying device are also included in the network and provided for the client which can communicate with the server via the network. Thus, it is possible to perform extremely useful suggestion by using the network.

Moreover, a part or all of the first database, the specifying device, the searching device, the image generating device, and the second database included in the server may be included in the client by downloading them via the network and used.

<Hairstyle Suggesting Method>

The above object of the present invention can be also achieved by a hairstyle suggesting method in a hairstyle suggesting system provided with: a first database for storing therein a plurality of hairstyle image data in association with feature parameters for indicating predetermined features of an arbitrary customer, the hairstyle suggesting method provided with: a specifying process of specifying at least one of the feature parameters corresponding to at least one of the features of one customer; a searching process of searching for hairstyle image data which matches the specified at least one of the feature parameters, from the hairstyle image data stored in the first database; an image generating process of generating a first image to be suggested to the one customer on the basis of the searched hairstyle image data; and a displaying process of displaying the first image.

According to the hairstyle suggesting method of the present invention, the hairstyle image data which matches at least one of the feature parameters specified by the specifying process is searched for by the searing process, so that it is possible to suggest the hairstyle that suits the customer.

Incidentally, in another aspect of the hairstyle suggesting method, if the first database further stores therein a plurality of hair color image data in association with the feature parameters, the searching process may further search for hair color image data which matches at least one of the feature parameters specified by the specifying process. Moreover, the image generating process may further generate a second image to be suggested to the one customer whose at least one of the feature parameters is specified, on the basis of the hair color image data, and the displaying process may further display the second image. According to hairstyle suggesting method of the present invention, it is also possible to suggest the hair color that suits the customer.

Moreover, the specifying process may be provided with: an image pickup process of imaging the one customer; and a customer image data generating process of generating image data of the imaged customer, and may specify at least one of the feature parameters on the basis of the generated image data of the customer. According to this aspect, at least one of the feature parameters can be specified objectively, so that it is possible to further improve the suggestion quality for the customer.

<Computer Program Product>

The above object of the present invention can be also achieved by a computer program product in a computer-readable medium for tangibly embodying a program of instructions executable by a computer to make the computer function as the above-described hairstyle suggesting system (including its various aspects).

According to the computer program product of the present invention, the above-described hairstyle suggesting system of the present invention can be embodied relatively readily, by loading the computer program product from a recording medium for storing the computer program product, such as a ROM (Read Only Memory), a CD-ROM (Compact Disc - Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-described hairstyle suggesting system.

Incidentally, in response to various aspects in the above-described hairstyle suggesting system of the present invention, the computer program product of the present invention can also adopt various aspects.

As explained above, according to the hairstyle suggesting system of the present invention, it is provided with: the first database; the specifying device; the searching device; the image generating device; and the displaying device, so that it is possible to suggest the hairstyle or the hair color that suits the customer. According to the hairstyle suggesting method of the present invention, it is provided with: the specifying process; the searching process; the image generating process; and the displaying process, so that it is possible to suggest the hairstyle or the hair color that suits the customer. According to the computer program product of the present invention, it makes the computer function as the above-described hairstyle suggesting system, so that it is possible to realize the above-described hairstyle suggesting system, relatively easily.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a conceptual diagram showing a hairstyle suggesting system in an embodiment of the present invention;

FIG. 2 is a block diagram showing a terminal system in the hairstyle suggesting system;

FIG. 3 is a block diagram showing a server in the hairstyle suggesting system;

FIG. 4 is a schematic diagram showing a customer chart stored in a CSDB; and

FIG. 5 is a flowchart showing a hairstyle suggesting service realized by the hairstyle suggesting system.

### DETAILED DESCRIPTION OF THE PREFERRED EMBODIMENT

The embodiment of the present invention will be explained with reference to the drawings hereinafter.

### Structure of Embodiment

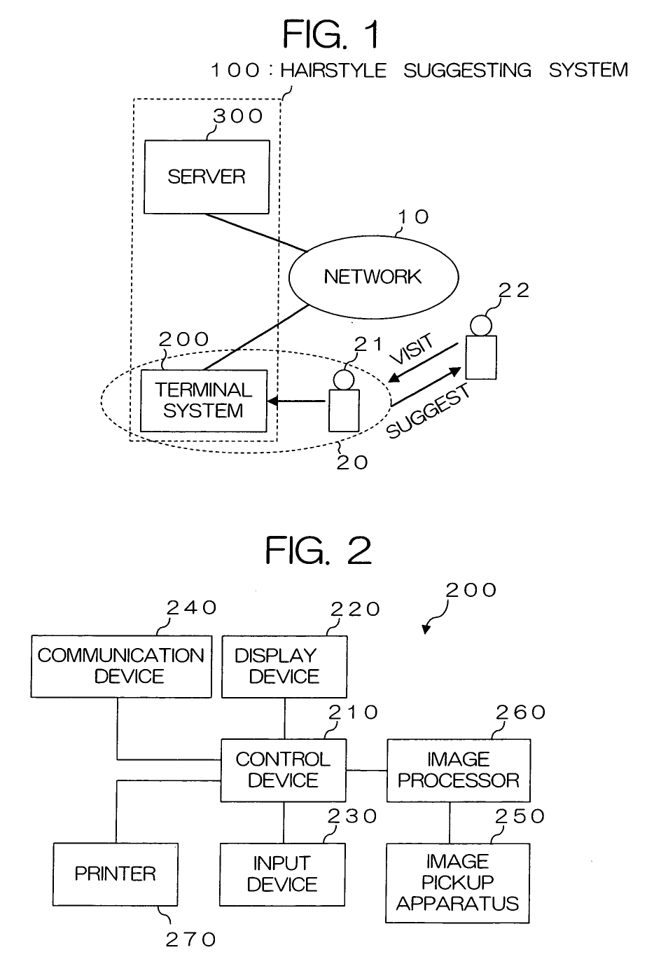

At first, with reference to FIG. 1, the structure of a hairstyle suggesting system in the embodiment of the present invention will be explained. FIG. 1 shows a hairstyle suggesting system 100.

In FIG. 1, the hairstyle suggesting system 100 is provided with: a terminal system 200; and a server 300, both of which are individually connected to a network 10.

The network 10 is a wide area network, represented by an Internet environment or the like which uses a general phone line, ADSL (Asymmetric Digital Subscriber Line), or the like, for example. Incidentally, the network 10 may be a LAN (Local Area Network), represented by the Ethernet (registered trademark) standard.

The terminal system 200 is one example of the “client” of the present invention. The terminal system 200 is installed at a beauty shop 20, and can communicate with the server 300 via the network 10. In the terminal system 200, for example, a stylist 21 who works for the beauty shop 20 can suggest a hairstyle that suits a customer 22, to the customer 22 who comes to the beauty shop 20. Incidentally, the customer 22 in the embodiment indicates one of the general public customers who come to the beauty shop 20.

Now, with reference to FIG. 2, the detailed structure of the terminal system 200 will be explained. FIG. 2 shows the terminal system 200.

In FIG. 2, the terminal system 200 is provided with: a control device 210; a display device 220; an input device 230; a communication device 240; an image pickup apparatus 250; an image processor 260; and a printer 270.

The control device 210 can control the operation of each device described later of the terminal system 200.

The display device 220 is a display monitor constructed from a plasma display or the like. The display device 220 can display an image transmitted from the server 300 when a hairstyle is suggested to the customer 22.

The input device 230 is a pointing device, such as a keyboard and a mouse. The stylist 21 (indicating a beautician, hairdresser, or the like) can input the attributes and the like of the customer 22, which will be described later, through the input device 230. Incidentally, the input device 230 may be integrated or unified with the display device 220, as in a touch panel display.

The communication device 240 is a modem or the like, for example. The communication device 240 allows the data to be transmitted and received between the terminal system 200 and the server 300.

The image pickup apparatus 250 is one example of the “image pickup device” of the present invention. The image pickup apparatus 250 is a digital camera, for example, and can image or photograph the customer 22 at various angles or in various directions.

The image processor 260 can generate the image data of the customer 22 imaged by the image pickup apparatus 250. The image processor 260 may be integrated with the image pickup apparatus 250, or may be able to convert the externally inputted image of the customer 22 to the image data, as in a scanner apparatus, for example.

The printer 270 is a printer apparatus of an ink jet type or a laser type, for example. The printer 270 can print the content displayed on the display device 220, in accordance with the control by the control device 210.

Back in FIG. 1, the server 300 is operated on the network 10, and can transmit and receive the data, with respect to the terminal system 200 to which the server 300 is connected via the network 10. Incidentally, in the embodiment, only a user who is registered as a member (which is namely the beauty shop 20 in this case) is allowed to access the server 300. The server 300 can provide a hairstyle suggesting service described later, for the user who is allowed to access.

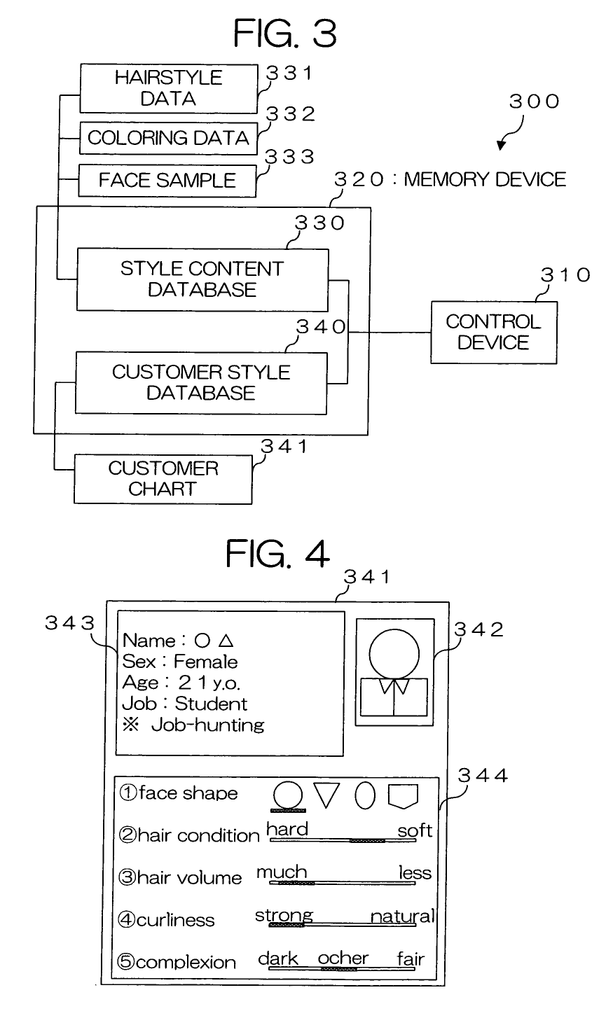

Now, with reference to FIG. 3, the detailed structure of the server 300 will be explained. FIG. 3 shows the server 300.

In FIG. 3, the server 300 is provided with: a control device 310; and a memory device 320.

The control device 310 controls the operation of the server 300, and can function as one example of each of the “specifying device”, the “searching device”, and the “image generating device” of the present invention.

The memory device 320 is provided with: a Style Content DataBase (hereinafter referred to as a “SCDB” as occasion demands) 330; and a Customer Style DataBase (hereinafter referred to as a “CSDB” as occasion demands) 340.

The SCDB 330 is one example of the “first database” of the present invention. The SCDB 330 can store therein a hairstyle data 331, a coloring data 332, and a face sample 333.

The hairstyle data 331 is one example of the “plurality of hairstyle image data” of the present invention. For example, the hairstyle data 331 is several thousand types of hairstyle image data. In the embodiment, individual hairstyle image data constituting the hairstyle data 331 are the image data observed in four directions of the front (i.e. a face), both lateral sides, and the rear. Incidentally, there is no limitation in the number of types of hairstyles constituting the hairstyle data 331. Moreover, even the individual hairstyle image data may include not only the image data observed in the four directions described above, but also image data observed in various directions. Alternatively, the individual hairstyle image data may be only image data observed from the front, for example. Incidentally, from now on, the individual hairstyle image data constituting the hairstyle data 331 is referred to as “hairstyle data” as occasion demands.

The coloring data 332 is one example of the” plurality of hair color image data” of the present invention. For example, the coloring data 332 is several hundred types of hair color image data. The coloring data 332 may be merely color data, such as a color sample, or may be image data which facilitates the imaging of a hair color by coloring a hairstyle which is a sample. Moreover, the coloring data 332 may be image data in which a certain amount of a strip of hair, which is referred to as a hair-bundle, is colored. Incidentally, the number of types of hair colors shown by the coloring data 332 is not limited to the several hundred types described here, and may be arbitrarily determined. Incidentally, from now on, individual hair color image data constituting the coloring data 332 is referred to as “coloring data” as occasion demands.

The face sample 333 is one example of the “sample image data including the head portion” of the present invention. For example, the face sample 333 is several thousand types of face image data. The face image data of a fashion model or the like is used for the image data. Moreover, the face sample 333 includes four image data observed in the same directions as those of the hairstyle data 331. Incidentally, the number of the image data in one face sample 333 is not limited to this. Incidentally, as with the hairstyle data 331, from now on, individual face image data constituting the face sample 333 is referred to as a “face sample” as occasion demands.

On the other hand, the hairstyle data 331, the coloring data 332, and the face sample 333 are stored in the SCDB 330 such that they are individually associated with feature parameters and attributes for specifying the customer 22.

The feature parameters are provided with a plurality of categories for indicating physical features about the head portion of the customer 22, such as a face shape, a hair condition, a hair volume, curliness, and complexion. The feature parameter about the category of the face shape is provided with values for specifying a round shape, a heart or inverted triangular shape, an oblong shape, a square shape, a pentagon or baseball's home plate shape, and the like. About the hair condition, there is provided values for indicating the hair condition from “hard” to “soft” in stages. About the hair volume, there is provided values for indicating the hair volume from “much” to “less” in stages. About the curliness, there is provided values for indicating the hair volume from “strong” to “natural” in stages. Moreover, the feature parameter for indicating the complexion is provided with values for indicating the complexion from “dark”, “ocher”, to ” fair” in stages.

The attributes are parameters provided with a plurality of categories for indicating the lifestyle of the customer 22, such as age, sex, job, hobby, and purposes. In each category, the attributes are individually given as attribute data. For example, in the case of sex, either “male” or “female” is the attribute data. In the case of age, age groups separated in a certain age range are the attribute data. Moreover, in the case of job, a job selected from a plurality of jobs or types of jobs prepared in advance is the attribute data. In the case of hobby, “tennis”, “cooking”, or the like is the attribute data. Moreover, attribute information for indicating the purposes, various purposes or situations, such as “playing outdoor sports” and “attending a wedding ceremony”, is the attribute data.

The SCDB 330 stores therein the hairstyle data 331, the coloring data 332, and the face sample 333, together with matching information about the matching feature parameters and the matching attribute data. Such a storage form is one example of the “association” of the present invention.

Incidentally, the hairstyle data 331 and the coloring data 332 are not necessarily associated with all the feature parameters and the attribute data. For example, it is considered that the hair color hardly has a correlation with the face shape, and what is considered to have the strongest correlation with the hair color is the feature parameter about the complexion. Therefore, the coloring data 332 may be associated with only the feature parameter about the complexion. On the contrary, the hairstyle and the feature parameter about the complexion have a low correlation, so that the hairstyle may not be associated with the feature parameter about the complexion in advance.

Incidentally, the face sample 333 is the face shape sample image data. Thus, it is enough to associate the feature parameter about the face shape with the attributes of age and sex, so as to select a face shape similar to rather than matched with that of the customer 22.

Incidentally, information about which feature parameter or which attribute data is matched with the individual hairstyle data, is determined in advance, regardless of preference at each shop and the subjective references of customers, in order not to vary a reference or a standard among all the beauty shops connected to the server 300. For example, such information is given, on the basis of the opinions of a plurality of hair stylists referred to as “charisma beauticians” in Japan, the aggregated total of questionnaire for the general public, and the like. Thus, it has high objectivity.

Moreover, there is a trend in the hairstyle and the hair color. Depending on the trend, a new hairstyle likely appears, and a hairstyle regarded as “it does not suit you” could be evaluated as “it suits you”. Thus, the data stored in the SCDB 330 can be newly added, and the matching feature parameter and attribute data can be updated as occasion demands.

The CSDB 340 is one example of the “second database” of the present invention, and is a database peculiarly installed at the beauty shop 20. The CSDB 340 can store therein the attribute data and the feature parameters of the customer 22. The attribute data and the feature parameters for each customer 22 are stored as a customer chart 341 on the CSDB 340.

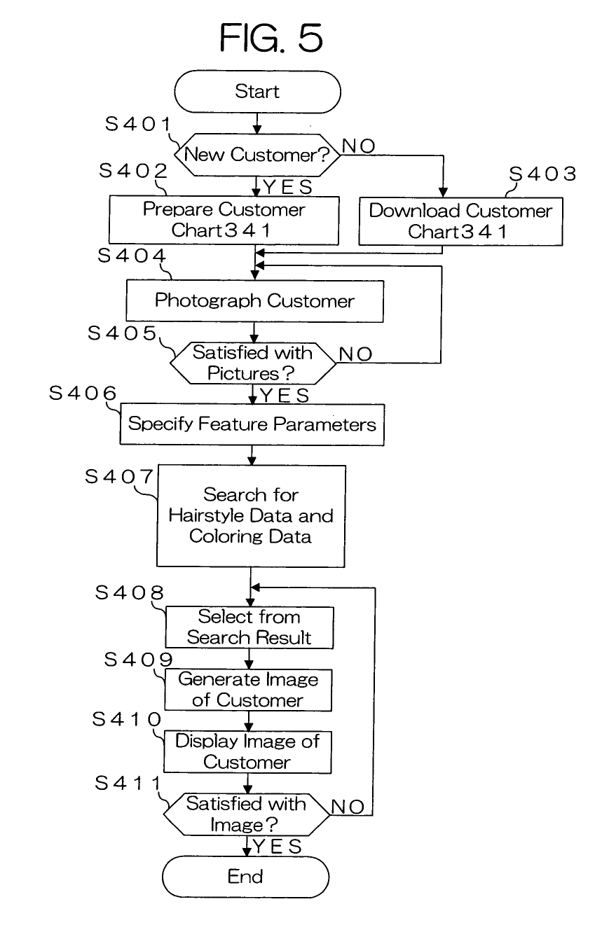

Now, with reference to FIG. 4, the customer chart 341 will be explained. FIG. 4 shows the customer chart 341.

In FIG. 4, the customer chart 341 is provided with: a customer image area 342; an attribute area 343; and a feature parameter area 344. In the customer image area 342, an image for identifying the customer 22, such as the face picture of the customer 22, is displayed. In the attribute area 343, the attributes described above are shown as the attribute data. Namely, a name, sex, age, job, date of visit, purposes, and the like are shown. Moreover, in the attribute area 343, supplemental information can be recorded to clarify the character of the customer 22, such as favorite fashion brand names and magazines the customer 22 often reads, apart from the attributes prepared in advance. In the feature parameter 344, the feature parameters described above are recorded. For example, the customer 22 shown in FIG. 4 has a round face, soft, much volume, strongly curly hair, and an ocher skin.

### Operation of Embodiment

Next, with reference to FIG. 5, the operation of the hairstyle suggesting system 100 will be explained with the content of the hairstyle suggesting service performed by using the hairstyle suggesting system 100. Here, FIG. 5 shows the hairstyle suggesting service.

At the beauty shop 20, the terminal system 200 is connected to the server 300 all the time. When the customer 22 comes to the beauty shop 20, at first, it is judged whether or not the customer 22 is a new customer at the beauty shop 20 (step S401). If the customer 22 is a new customer who comes to the beauty shop 20 (the step S401: YES), the stylist 21 who is in charge of the customer 22 (hereinafter referred to as a “stylist in charge” as occasion demands) prepares the customer chart 341 for the customer 22 (step S402).

In preparing the customer chart 341, at first, a predetermined form with columns of a name, age, job, and the like is given to the customer 22, and is filled in by the customer 22 as occasion demands. After the fill-in of the form, the stylist in charge inputs the filled-in content from the input device 230, and transmits it to the server 300. On the server 300, the control device 310 generates a new customer chart 341 on the basis of the transmitted data. The generated customer chart 341 is stored into the CSDB 340 as new customer information, and transmitted to the terminal system 200, by the control device 310. In the terminal system 200, the image of the customer chart 341 received via the communication device 240 is displayed on the display device 220. The customer chart 341 displayed at this time point is a chart on which only the attribute area 343 is recorded.

On the other hand, if the customer 22 is not a customer who newly comes to the beauty shop 20 (the step S401: NO), the stylist in charge downloads the customer chart 341 of the customer 22 from the server 300 (step S403). The control device 310 searches the CSDB 340 for the customer chart 341 of the corresponding customer 22, and transmits it to the terminal system 200. In the terminal system 200, the image of the customer chart 341 received via the communication device 240 is displayed on the display device 220.

If the customer chart 341 of the customer 22 is displayed on the display device 220 in the step S402 or the step S403, the customer 22 is photographed (step S404).

The stylist in charge images or photographs the customer 22 with the image pickup apparatus 250. At this time, four pictures in total, i.e. the front, both lateral sides, and the rear, are taken. Moreover, the close-up picture of the hair is also taken for the measurement of the hair condition. The taken images are converted to image data by the image processor 260, and displayed on the display device 220.

The customer 22 judges whether or not the pictures are satisfying (step S405). If not satisfied with the pictures (the step S405: NO), the customer 22 asks the stylist in charge to photograph until satisfied. If satisfied with the pictures (the step S405: YES), the customer 22 says so to the stylist in charge. The stylist in charge gives an instruction from the input device 230 to transmit the image data of the customer 22 to the server 300. The control device 210 transmits the image data of the customer 22 to the serve 300 via the communication device 240, on the basis of the inputted instruction.

On the server 300, the control device 310 specifies the feature parameters from the received image data of the customer 22 (step S406). At this time, the control device 310 specifies the feature parameters about the face shape and the complexion from the image data of the front of the customer 22, and specifies the feature parameters about the hair condition, the hair volume, and the curliness or the like from the image data of the hair. Reference data necessary for this specification is stored in advance on the server 300. Incidentally, the step S406 is one example of the “specifying process” of the present invention.

The specified feature parameters are reflected in the customer chart 341, and recorded as the newest feature parameters into the feature parameter area 344 of the customer chart 341. Moreover, if the customer chart 341 relates to the new customer 22, the control device 310 extracts the image data of the front from the received image data of the customer 22, and pastes it to the customer image area 342 of the customer chart 341. At this time point, the customer chart 341 is updated to the newest one.

The control device 310 refers to the feature parameters and the attribute data of the customer 22 from the customer chart 341, and searches for the hairstyle data and the coloring data that match the feature parameters and the attribute data of the customer 22, from the hairstyle data 331 and the coloring data 332 stored in the SCDB 330 (step S407). Incidentally, the step S407 is one example of the “searching process” of the present invention.

The search result is transmitted by the control device 310 to the terminal system 200. The control device 210 of the terminal system 200 displays the hairstyle data and the coloring data received via the communication device 240, as a list on the display device 220.

The customer 22 selects a desired hairstyle and hair color, from the hairstyle data and the coloring data displayed as the list on the display device 220 (step S408).

Incidentally, as a result of the search, if there is little hairstyle data that corresponds to the customer 22, it is possible to change a search condition. In the embodiment, the order of priority is given to the feature parameters recorded in the customer chart 341. Namely, the higher priority is given in order of the face shape, the hair condition, the hair volume, the curliness, and the complexion. This order of priority is given in order of stronger influence on the suitability for the customer 22. For example, even if the curliness and the complexion, which have lower priority, are disregarded, it does not detract from the suitability for the customer. On the other hand, the number of the search results increases by disregarding the two conditions, so that it expands the range of the selections of the customer 22, which is preferable.

On the contrary, if there are too much search results, it is possible to increase the search condition. For example, the referred attribute data of the customer 22 in the search associated with the control device 310, is not all the attribute data recorded in the customer chart 341. In the embodiment, the attribute data of sex, age, and purposes is set as reference values of default. Therefore, it is also easy to search for the hairstyle and the hair color which suit the customer 22 more, by adding job, hobby, and the like from the attribute data as the search condition.

If the hairstyle and the hair color are selected, the control device 310 generates an image to be suggested to the customer 22 on the server 300 (step S409). Specifically, the control device 310 extracts a portion corresponding to the face, from the image data of the customer 22, and matches the selected hairstyle and the selected hair color with the image data of the extracted face portion, to thereby generate the image of the customer 22. Incidentally, the step S409 is one example of the “image generating process” of the present invention.

The generated image of the customer 22 is a composite image of one example of the “first image” and one example of the “second image” of the present invention. The generated image of the customer 22 is transmitted to the communication terminal 200, and displayed by the control device 210 on the display device 220 (step S410). Incidentally, the step S410 is one example of the “displaying process” of the present invention.

Incidentally, in the embodiment, the hairstyle and the hair color are searched for and suggested at the same time, however, the aspect of the suggestion is not limited to this aspect. For example, firstly, the image of the customer about the hairstyle (i.e. one example of the “first image” of the present invention) may be generated and displayed on the display device 220, to thereby only perform the suggestion of the hairstyle. Then, on the basis of the determined image of the customer about the hairstyle, the image of the customer about the hair color (i.e. one example of the “second image” of the present invention) may be generated. According to such an aspect of the service, it is possible to perform efficient suggestion, even to customers who do not desire hair coloring and customers who desire only hair coloring. Moreover, the image of the hairstyle and the image of the hair color may be displayed in a line or side by side on one screen without the composition. In any case, the customer can confirm the image of the hairstyle and the image of the hair color at the same time, so that it is possible to perform extremely high-quality suggestion.

Even if the images of the customer about the hairstyle and the hair color are individually displayed on different screens without the composition, the effect of the present invention is ensured.

Incidentally, there may be a plurality types of hairstyle data and coloring data selected by the customer 22. For example, if there are 10 hairstyle data desired by the customer 22 in the final search result, the image may be generated for each of the 10 hairstyle data.

Some customers 22 may not want the images of their own face portions to be used for the displayed image. In that case, the terminal system 200 may require the control device 310 of the server 300 to search for a face sample which is similar to the face of the customer 22 from the face sample 333 stored in the SCDB 330, on the basis of the feature parameter about the face shape of the customer 22 and the attribute data of age and sex, and to transmit it to the terminal system 200.

The customer 22 judges whether or not the image displayed on the display device 220 is satisfying (step S411). If not satisfied with the displayed image (the step S411: NO), the customer 22 selects a new hairstyle or a new hair color, and the generation and display of the image continue until the customer 22 is satisfied. If the customer 22 is satisfied with the displayed image (the step S411: YES), the image is recorded by the control device 310 onto the customer chart 341 as the final suggestion result. Then, it is printed on a medium, such as paper, by the printer 270 in the terminal system 200, and handed to the customer 22. Then, the hairstyle suggesting service ends.

As explained above, according to the hairstyle suggesting system 100 in the embodiment, it is possible to efficiently suggest the hairstyle and the hair color that suit the customer 22.

The feature parameters are not necessarily specified on the basis of the image data generated by the image pickup apparatus 250 and the image processor 260, as described here. For example, it is also possible to merely input the feature parameters of the customer from the input device 220. In this case, the stylist 21 can input the parameter to be suggested, to thereby suggest the hairstyle and the hair style to the customer 22.

Incidentally, in the above-described embodiment, the hairstyle suggesting system 100 is provided with the terminal system 200 and the server 300 which are connected to each other via the network 10. However, an application program by which the server 300 can be replaced, may be recorded in a recording medium, such as a CD-ROM and a DVD, and distributed to the terminal system 200. Here, the application program is one example of the “computer program product” of the present invention. In this case, it is also possible to perform the hairstyle suggesting service of the present invention only on the client side, by executing the application program associated with the control device 210, on the terminal system 200. Moreover, in that case, for example, fashionable hairstyles, newly released hair colors, and the like may be individually distributed as additional image data.

The place of installation of the terminal system 200 is not limited to the beauty shop 20. For example, the client may receive and use a part or all of the functions of the specifying device, the detecting device, and the image generating device, or the control device 310 corresponding to the above devices, by downloading them via a network, or the like. By this, the customer can use the hairstyle suggesting system of the present invention, even from mobile equipment, such as a terminal at home connected to a network and a cell-phone, without limitation in place, such as the beauty shop.

Incidentally, the aspect of the hairstyle suggesting service performed by using the hairstyle suggesting system 100 is not limited to the above-described aspect. For example, apart from the suggesting the hairstyle and the hair color that suit the customer, it is also possible to objectively judge the suitability with the customer 22 of the hairstyle or hair color desired by the customer 22.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-139016 filed on May 7, 2004 including the specification, claims, drawings and summary is incorporated herein by reference in its entirety.

1. A hairstyle suggesting system comprising:
a first database for storing therein a plurality of hairstyle image data in association with feature parameters for indicating predetermined features of an arbitrary customer;
a specifying device for specifying at least one of the feature parameters corresponding to at least one of the features of one customer;
a searching device for searching for hairstyle image data which matches the specified at least one of the feature parameters, from the plurality of hairstyle image data stored in said first database;
an image generating device for generating a first image to be suggested to the one customer on the basis of the searched hairstyle image data; and
a displaying device for displaying the first image.

2. The hairstyle suggesting system according to claim 1, wherein
said first database further stores therein a plurality of hair color image data in association with the feature parameters,
said searching device further searches for hair color image data which matches the specified at least one of the feature parameters, from the plurality of hair color image data stored in said first database,
said image generating device further generates a second image to be suggested to the one customer on the basis of the searched hair color image data, and
said displaying device further displays the second image.

3. The hairstyle suggesting system according to claim 2, wherein said image generating device generates the second image on the basis of the searched hair color image data and the generated first image.

4. The hairstyle suggesting system according to claim 1, wherein said specifying device comprises: an image pickup device for imaging the one customer; and a customer image data generating device for generating image data of the imaged customer, and specifies at least one of the feature parameters on the basis of the generated image data of the customer.

5. The hairstyle suggesting system according to claim 2, wherein said specifying device comprises: an image pickup device for imaging the one customer; and a customer image data generating device for generating image data of the imaged customer, and specifies at least one of the feature parameters on the basis of the generated image data of the customer.

6. The hairstyle suggesting system according to claim 5, wherein said image generating device generates the first image or the second image on the basis of the generated image data of the customer and at least one of the searched hairstyle image data and the searched hair color image data.

7. The hairstyle suggesting system according to claim 5, wherein
said first database stores therein a plurality types of image data of samples each including a head portion in association with the feature parameters,
said searching device further searches for image data of a sample, which matches the specified at least one of the feature parameters, from the plurality of image data of samples stored in said first database, and
said image generating device generates the first image or the second image on the basis of (i) at least one of the searched hairstyle image data and the searched hair color image data and (ii) at least one of the generated image data of the customer and the searched image data of the sample.

8. The hairstyle suggesting system according to claim 1, wherein
there are a plurality types of feature parameters, and order of priority is given in advance to respective one of the feature parameters, and
said searching device searches for the hairstyle image data which matches the specified at least one of the feature parameters, in accordance with the order of priority.

9. The hairstyle suggesting system according to claim 2, wherein
there are a plurality types of feature parameters, and order of priority is given in advance to respective one of the feature parameters, and
said searching device searches for the hairstyle image data or the hair color image data which matches the specified at least one of the feature parameters, in accordance with the order of priority.

10. The hairstyle suggesting system according to claim 2, further comprising an outputting device which can output the first image or the second image which is displayed on said displaying device, to a predetermined recording medium.

11. The hairstyle suggesting system according to claim 2, wherein at least one of the plurality of hairstyle image data and the plurality of hair color image data, which are stored in said first database, can be added, deleted, or changed.

12. The hairstyle suggesting system according to claim 11, wherein said first database newly stores therein at least one of the generated first image and the generated second image, as at least one of the hairstyle image data and the hair color image data.

13. The hairstyle suggesting system according to claim 2, further comprising:
an inputting device capable of inputting therethrough predetermined attributes for indicating basic attributes of the one customer, as attribute data, for each customer; and
a second database for storing therein the inputted attribute data for each customer, wherein
said second database further stores therein the specified at least one of the feature parameters in association with the inputted attribute data,
said first database further stores therein at least one of the hairstyle image data and the hair color image data, in association with the attributes,
said searching device further searches said first database for at least one of the hairstyle image data and the hair color image data which match the inputted attribute data, and
said image generating device further generates the first image or the second image on the basis of at least one of the searched hairstyle image data and the searched hair color image data.

14. The hairstyle suggesting system according to claim 13, wherein
said first database, said specifying device, said searching device, said image generating device, and said second database are included in a network and provided for a server communicable via the network,
said inputting device and said displaying device are included in the network and provided for a client which can communicate with the server via the network,
the client transmits the inputted attribute data to the server via the network,
the server stores the transmitted attribute data into the second database, and transmits at least one of the first and second images generated by said image generating device, to the client via the network, and
the client displays the received first or second image.

15. A hairstyle suggesting method in a hairstyle suggesting system comprising: a first database for storing therein a plurality of hairstyle image data in association with feature parameters for indicating predetermined features of an arbitrary customer,
said hairstyle suggesting method comprising:
a specifying process of specifying at least one of the feature parameters corresponding to at least one of the features of one customer;
a searching process of searching for hairstyle image data which matches the specified at least one of the feature parameters, from the hairstyle image data stored in said first database;
an image generating process of generating a first image to be suggested to the one customer on the basis of the searched hairstyle image data; and
a displaying process of displaying the first image.

16. A computer program product in a computer-readable medium for tangibly embodying a program of instructions executable by a computer to make the computer function as a hairstyle suggesting system,
said hairstyle suggesting system comprising:
a first database for storing therein a plurality of hairstyle image data in association with feature parameters for indicating predetermined features of an arbitrary customer;
a specifying device for specifying at least one of the feature parameters corresponding to at least one of the features of one customer;
a searching device for searching for hairstyle image data which matches the specified at least one of the feature parameters, from the hairstyle image data stored in said first database;
an image generating device for generating a first image to be suggested to the one customer on the basis of the searched hairstyle image data; and
a displaying device for displaying the first image.
